(19) United States
(12) Patent Application Publication
(10) Pub. No.: US 2010/0050129 A1
(43) Pub. Date: Feb. 25, 2010

(54) 3D Graphical User Interface For Simultaneous Management Of Applications

(75) Inventors: Jisheng Li, Los Altos, CA (US); Yuan Feng, Shenzhen (CN); Chunyang Sun, Shenzhen (CN)

Correspondence Address: Venture Pacific Law, PC, 5201 Great America Parkway, Suite 270, Santa Clara, CA, 95054, US

(73) Assignee: AUGUSTA TECHNOLOGY, INC., Santa Clara, CA (US)

(21) Appl. No.: 12/544,220

(22) Filed: Aug. 19, 2009

Related U.S. Application Data
(60) Provisional application No. 61/090,225, filed on Aug. 19, 2008.

(51) Int. Cl. G06F 3/048

(52) U.S. Cl. 715/849

(57) ABSTRACT

A method for providing a graphical user interface for an electronic device, wherein the electronic device having a display and a plurality of associated applications, comprising the steps: generating the appearance of a virtual three dimensional object having a plurality of panels, wherein the panels are positioned on the surface of the object; associating each of the panels to one of the applications; and displaying two or more of the panels of the object on the display, wherein the associated applications of the panels are displayed.

### CROSS REFERENCE

This application claims priority from a provisional patent application entitled “3D Simultaneous Display and Switch” filed on Aug. 19, 2008 and having an Application No. 61/090,225. Said application is incorporated herein by reference.

### FIELD OF INVENTION

This invention relates to methods and systems for a graphical user interface (“GUI”) for an electronic device and, in particular, to methods and systems for a GUI having a virtual three dimensional object that simultaneously displays and manages various applications of an electronic device.

### BACKGROUND

In many respects, a graphical user interface (“GUI”) can be the most important feature of an electronic device, including a desktop computer, a laptop computer, a video game platform, a television, a personal digital assistant (“PDA”), a global positioning system (“GPS”) device, a mobile phone, and other electronic devices. One of the major functions of a GUI is to efficiently and conveniently select an application of an electronic device to launch.

Typically, a computer GUI can have a menu system that allows a user to launch an application. The menu system typically has a hierarchical structure in which a top-level menu contains a relatively small number of menu items, and each top-level menu item may expand into several sub-menus. Each sub-menu may further expand into several sub-sub-menus, and so on and so forth. A user can select a desired application by navigating through one or more menus or sub-menus, until a menu item corresponding to the desired application is displayed and selected. Additionally, a computer may have a shortcut to an application displayed on the display of the computer to launch the application. Navigation through a menu system and/or launching an application may be carried out by pointing and clicking a mouse, pressing navigation keys on a keyboard, typing a command on the keyboard, or manipulating other input devices typically associated with a computer system.

For a mobile phone GUI, the mobile phone GUI can have a similar menu system of a computer GUI. In addition, a phone may have two dimensional (“2D”) tiles arranged on a 2D grid, where each 2D tile can be associated with an application. Upon selection of a 2D tile, the associated application may be launched or a sub-menu with further 2D tiles can be displayed. Navigation and selection of a 2D tile can be carried out by pressing a touch sensitive display screen of the phone (e.g., on Apple's iPhone), by pressing buttons on a keypad of the phone, or by manipulating other input devices typically associated with a mobile phone.

Although GUIs have been widely used, they do not adequately display multiple applications simultaneously and do not conveniently switch from one application to another application. For instance, in a top down menu, each item must be read by the user to determine whether a menu item is desired. Furthermore, even shortcuts do not efficiently convey information to the user since the user must identify an application based on respective 2D icons/2D symbols of the shortcuts that are displayed. In many instances, a 2D icon/2D symbol is nothing more than an image and may bear little relation to its respective application to which it is a shortcut; thus, making it very difficult for a user to quickly discern one application from another application.

Therefore, it remains an ongoing goal to provide a GUI that is efficient, convenient, and intuitive to use. Some considerations to take into account in creating such a GUI is to provide a user-friendly interface, to simultaneously display various applications of an electronic device, to quickly toggle between various applications, and to increase overall user efficiency in operating the electronic device.

### SUMMARY OF THE INVENTION

An object of this invention is to provide methods and systems for a GUI that provides a user friendly interface.

Another object of this invention is to provide methods and systems for a GUI that simultaneously displays various applications of an electronic device in a format that is conducive for a user to quickly discern one application from another application.

Yet another object of this invention is to provide methods and systems for a GUI that can allow a user to quickly identify a desired application and switch to that desired application.

A method for generating a graphical user interface for an electronic device is disclosed, wherein the electronic device having a display and applications, comprising the steps: generating a virtual three dimensional object having a plurality of panels, wherein the panels are positioned on the surface of the object; associating each of the panels to one of the applications; and displaying the object on the display; wherein at least two of the panels of the object are viewable on the display, and wherein the associated application of each of the viewable panels are displayed on the associated viewable panel.

An advantage of this invention is that methods and systems are provided for a GUI that can provide a user friendly interface.

Another advantage of this invention is that methods and systems are provided for a GUI that can simultaneously display various applications of an electronic device in a format that is conducive for a user to quickly discern one application from another application.

Yet another advantage of this invention is that methods and systems are provided for a GUI that can allow a user to quickly identify a desired application and switch to that desired application.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1a illustrates a GUI according to an embodiment of the present invention having a form of a cube.

FIG. 1b illustrates a GUI according to an embodiment of the present invention having a form of a cube displayed on a mobile phone.

FIG. 2a illustrates a GUI according to an embodiment of the present invention having a form of a sphere where an application can be displayed on each band of the sphere.

FIG. 2b illustrates a GUI according to an embodiment of the present invention having a form of a sphere where the band of a selected application is enlarged.

FIG. 2c illustrates a GUI according to an embodiment of the present invention having a form of a sphere displayed on a mobile phone.

FIG. 3 illustrates a process flow for selecting an application utilizing a GUI according to an embodiment of the present invention.

FIG. 4 illustrates a process flow for simultaneously displaying various applications according to an embodiment of the present invention.

FIG. 5 illustrates a process flow for switching the display of one application to another application according to an embodiment of the present invention.

FIG. 6 illustrates a process flow for accepting/denying a phone call according to an embodiment of the present invention.

FIG. 7 illustrates a process flow for accepting/denying an instant message or email according to an embodiment of the present invention.

### DETAILED DESCRIPTION OF THE PREFERRED EMBODIMENTS

The present invention can be implemented using a variety of electronic devices, including desktop and laptop computers, video game platforms, televisions, PDAs, GPS devices, mobile phones, and other electronic devices. In order to aid in the understanding of the invention, a mobile phone is used in conjunction with the figures and the description below to aid in illustrating the present invention. However, it is to be understood that the methods and systems of the present invention can be used with any electronic device that comprises a display, processor, and storage. It is in no way to be construed to limit the present invention to mobile phones. In fact, the present invention claims to all electronic devices.

Additionally, any number of input buttons and input methods (e.g., physical buttons, a touch sensitive display, a computer keyboard, a mouse, other input means, and combinations thereof) may be used by a user of an electronic device to input commands to operate a GUI in accordance with an embodiment of the present invention.

The present invention relates to a GUI for an electronic device. The GUI can have the form of a three dimensional (“3D”) object (e.g. a cube, a sphere, a cylinder, an onion-shaped object, etc.). The 3D object is further comprised of panels, where each panel can be associated with an application. The user of the electronic device can navigate to a desired application by rotating the 3D object until the associated panel of the desired application is displayed. Once displayed, the user can select that application to launch a full view of the application. The 3D object can be freely rotated in any direction.

Since the display of the electronic device is two dimensional, the 3D object of the GUI may be provided with scaling, shadowing, and other effects that can give a three-dimensional appearance to the object when viewed on the display of the electronic device. The 3D object can be made to appear to have depth rather than being two dimensional, thus creating an effect that results in some panels of the 3D object appearing closer to the user than other panels on the 3D object. The user can select the panel that is seemingly closer in depth to the user than the other panels of the 3D object.

Navigation keys or other input mechanisms on the electronic device can be used to rotate or otherwise move the 3D object, such that the panels of the 3D object can appear to be rotated or moving. The panel appearing closest to the user can be selected to launch the associated application of the panel.

A user of the electronic device can press navigation keys or similar input mechanisms on the electronic device to bring a desired panel into view on the display of the electronic device (i.e., a viewable panel). For example, a ‘left’ key may be used to rotate the 3D object to the left of the display; a ‘right’ key may be used to rotate the 3D object to the right of the display; an ‘up’ key may be used to rotate the 3D object in an upward direction; a ‘down’ key may be used to rotate the 3D object in a downward direction; and so on and so forth. Combinations of the directional keys can also be used to provide angled directions, e.g. rotating in the upper-left direction by pressing the “up” key and the “left” key at the same time. In this manner, panels that were not viewable on the display (e.g., that were on the back side of the 3D object) can be rotated into a viewable position on the display (e.g., on the front side of the 3D object that is viewable on the display). The panels that were originally in a viewable position on the display can be rotated to a non-viewable position (e.g., on the back side of the 3D object).

In an embodiment of the present invention, the user may select one of the viewable panels to launch the associated application by pressing a designated key on the electronic device to select this viewable panel. Alternatively, the user may simply touch the viewable panel that is displayed on a touch screen of the electronic device to launch the associated application of that viewable panel.

In another embodiment, each viewable panel may have varying viewable surface areas on the display. The viewable surface area of each panel can be dependent on the relative position of the panel on the 3D object. For instance, a panel on the 3D object that is meant to be closer in depth to the user may have a greater viewable surface area than a panel on the 3D object that is meant to be further away from the user.

The viewable panel with the largest viewable surface area (e.g., the panel that appears to be closest to the user) can be selected by pressing a designated key such that the associated application of that panel is launched and maximized on the display of the electronic device. Navigation keys and other navigation methods can be used to rotate the 3D object such that each panel can be selected by the designated key.

Also, shortcuts can be placed adjacent to the 3D object such that the shortcut can be selected by the user to launch an associated application without having to rotate or move the 3D object.

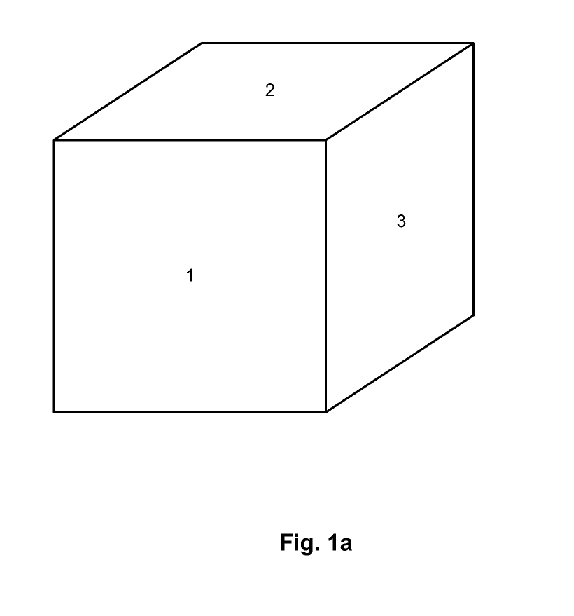

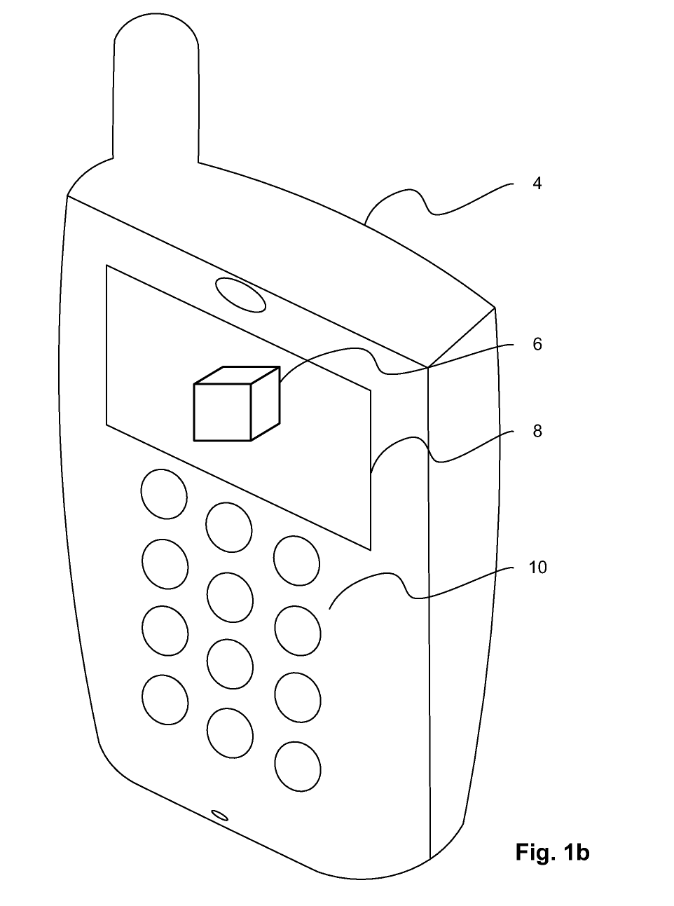

FIG. 1a illustrates a GUI according to an embodiment of the present invention having a form of a cube. Each rectangular side of a cube can be a panel. Thus, there are six panels since a cube has six rectangular sides. Here, panel 1, panel 2 and panel 3 are viewable panels since these panels are viewable on the display. Thus, panel 1, panel 2, and panel 3 can be described as being on the front side of the cube since these panels are viewable on the display of the GUI. Panel 1 may have a greater viewable surface area (or a different color) than panel 2 and panel 3 to indicate that it can be selected by pressing a designated key. Also, if the GUI is displayed on a touch sensitive screen, then panel 1, panel 2, or panel 3 can be selected by touching the viewable surface area of the respective panel on the touch sensitive screen. The other panels of the cube are on the back side of the cube, therefore are not viewable on the display. The cube can be rotated in any direction to display a desired panel for selecting the associated application of that panel.

Additionally, each rectangular side can be partitioned into multiple panels to increase the number of applications that can be associated with one side of a rectangular side.

With respect to each panel, a panel can act as a preview window to display the associated application of an electronic device on that panel. For instance, if the associated application of one of the panels of a 3D object is a Google search webpage, then a Google search webpage is displayed on this panel. If a GPS application is associated to one of the panels of the 3D object, then a map with the current location of the electronic device can be displayed on this panel. If a video application is set to one of the panels of the 3D object, then a video clip may be played on this panel. Since multiple panels of the 3D object are displayed at any one time, previews of multiple applications are simultaneously displayed on the 3D object. The GUI can be used to quickly discern one application from another application by simultaneously viewing the displayed applications on the 3D object.

Since there may be more applications than panels on the 3D object, the user can select a specific panel to be associated with a selected application. Thus, a user can predefine the applications associated with the panels of a 3D object.

FIG. 1b illustrates a GUI according to an embodiment of the present invention having a form of a cube displayed on a mobile phone. A mobile phone 4 displays a GUI having a cube shape on a display of the mobile phone 8. The buttons 10 can be used to rotate and move the cube shaped object 6 to a panel associated with a desired application.

Additionally, the screen 8 may be touch sensitive such that the cube can be rotated or moved by a user touching the touch sensitive screen. For instance, if the touch sensitive screen 8 sense movement from right to left on (or near) the screen 8, then the cube can be rotated to the left. If the touch screen 8 senses movement from left to right on (or near) the screen 8, then the cube can be rotated right. Other commands can be implemented in a similar manner such that the cube can be rotated in other directions. Furthermore, a specific panel can be selected by touching the viewable surface area of the panel on the touch sensitive screen.

With respect to the shape of a 3D object, the 3D object can also be shaped like a sphere where a number of available applications can be displayed on the surface of the sphere as the user rotates the sphere in one direction or another. The surface of the sphere can be partitioned into panels, where each panel can appear to be bands that span along an axis of the sphere (e.g., a horizontal axis of the sphere, a left-down diagonal axis of the sphere, a left-up diagonal axis of the sphere, etc.). Furthermore, different panels can be shown depending on the direction of rotation. For example, a first set of panels may be shown when the 3D object is rotated in a vertical-down direction, a second set of panels may be shown when the 3D object is rotated in vertical-up direction, a third set of panels may be shown when the 3D object is rotated in a left-to-right diagonal-down direction, a fourth set of panels may be shown when the 3D object is rotated in a right-to-left diagonal-up direction, etc. The first set of panels may be set to system related applications; the second set of panels may be set to video related applications; and the third set of panels may be set to phone related functions; and etc.

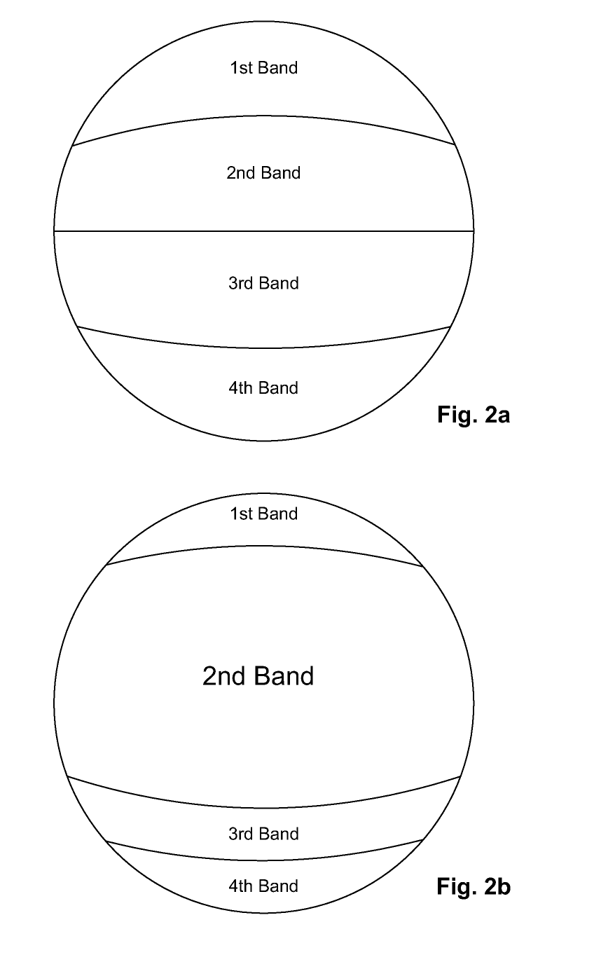

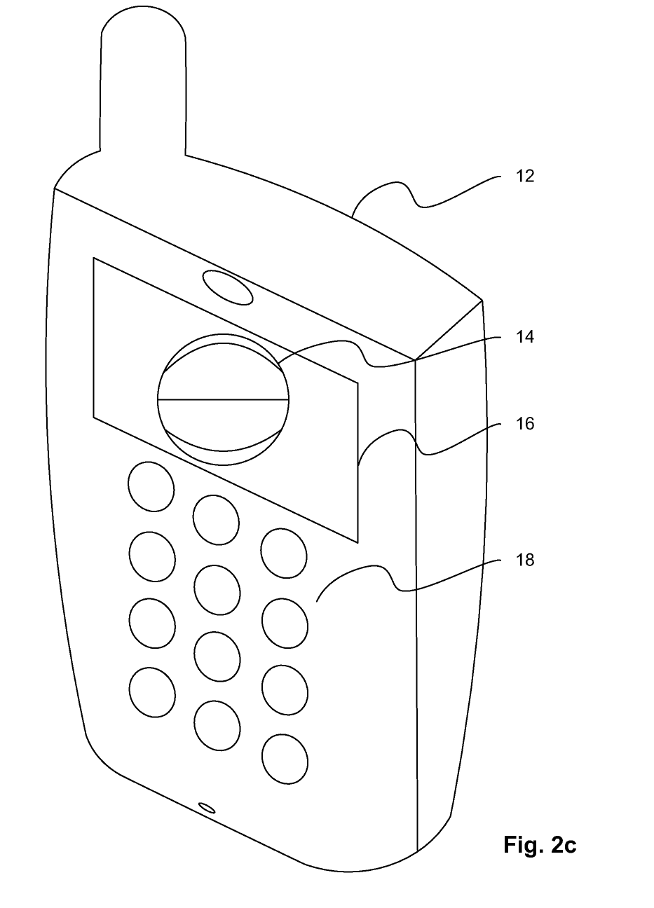

FIG. 2a illustrates a GUI according to an embodiment of the present invention having a form of a sphere where an application can be displayed on each band of the sphere. The sphere can be designed into a number of bands, where each band displays and links to an associated application (or features, designs, functions, etc. or combinations thereof) as designated. For example, a first band displays running applications, the second band displays available applications, the third band displays favorite applications, and the fourth band displays favorite pictures. If the sphere is rotated or touched by flicking the desired band on a touch sensitive display, that band can be magnified (see FIG. 2b where the second band is selected and magnified). The number of bands available on the sphere can be infinite in number where only a pre-defined number of bands are viewable on the display at any one time. The other non-viewable bands can be made viewable (i.e., viewable on the display of the electronic device) as the sphere is rotated to uncover those bands.

FIG. 2c illustrates a GUI according to an embodiment of the present invention having a form of a sphere displayed on a mobile phone. A mobile phone 12 displays a GUI having a sphere shape on a display of the mobile phone 16. The buttons 18 can be used to rotate and move the sphere shaped object 14 to a band associated with a desired application.

Additionally, the screen 16 may be touch sensitive such that the sphere can be rotated or moved by a user touching the touch sensitive screen. For instance, if the touch sensitive screen senses movement from right to left on (or near) the touch screen, then the sphere can be rotated to the left. If the touch sensitive screen senses movement from the left to right on (or near) the touch screen, then the cube can be rotated right. Other commands can be implemented in a like manner such that the sphere can be rotated in any direction. Furthermore, a specific panel can be selected by touching the viewable surface area of the panel on the touch sensitive screen.

The concept of bands described in the above can be applied in any shape and/or size; it is not limited to the shape in FIGS. 2a-2c. For example, it can be applied to any shaped panel on the surface of a 3D object, such that multiple panels are on the surface of the 3D object. When a panel is selected, it can be magnified from its original size on the surface of the 3D object; and when the panel is de-selected, it can be shrunk to its original size on the surface of the 3D object.

Furthermore, the concept of bands/patches for displaying applications, features, pictures, etc. can be applied to other 3D objects (e.g., a cube, polyhedron, and other 3D objects). For instance for a cube, as the cube is rotated, a different application is prominently displayed and magnified; and when the application is deselected, it returns to its previous band size on the cube. Note that in rotating a cube, it is not necessary to limit the number of bands to the six rectangular surfaces since multiple bands can be positioned on each rectangular surface. In addition, there can be a large number of rectangular surfaces since it is a virtual display method which can be applied to polyhedrons in general.

With respect to 3D polyhedrons or other many sided 3D objects, different types of objects (such as pictures, music, maps, applications, features, favorite phone numbers, etc.) can be displayed depending on how the polyhedron is rotated. For example, if a polyhedron is rotated horizontally, available applications are magnified and displayed; if a polyhedron is rotated vertically, running applications are magnified and displayed; if a polyhedron is rotated from the left upper corner down to the right lower corner, pictures are magnified and displayed; if a polyhedron is rotated from the right upper corner down to the left lower corner, available music albums are magnified and displayed; and so on and so forth.

A number of buttons may be provided around the 3D object for access to further applications or functions. For example, four buttons may be provided below the cube, where these can be referred to as “shortcut” buttons to applications. Anyone of these buttons can be selected to launch the associated application.

The applications running on an electronic device and displayed on the 3D object may be simultaneously (or transparently) displayed with other applications on the different panels of the 3D object. The display of one or more applications can be switched to another set of one or more applications by rotating the 3D object, thus rotating the panels of the 3D object in the virtual world.

At each panel of the 3D object, the associated application of the panel can be displayed. For example, a first panel of a 3D cube can display an email browsing application, a second panel of the 3D cube can display an Internet browser application, a third panel of the 3D cube can display a video clip for a television application, a fourth panel of the 3D-cube can display a phone dialing application, and so on and so forth. In such a setup, a user can watch a football game on one panel using the television application, while checking his/her email on another panel using he email browsing application.

With a touch sensitive screen for mobile phones, special features can be designed and utilized. For example, on the top of the desktop screen, a “To-Cube” button may be provided. If the panel is ‘flicked’ (i.e., senses a nearby or touching object) by an object (e.g., a user's finger), the 3D cube may be rotated with other surfaces being viewed. The cube can be scrolled by dragging the object along the screen to move the 3D cube in various directions. A panel can be tapped twice or double clicked to launch an associated application of that panel. These features can be further customized for mobile phone applications.

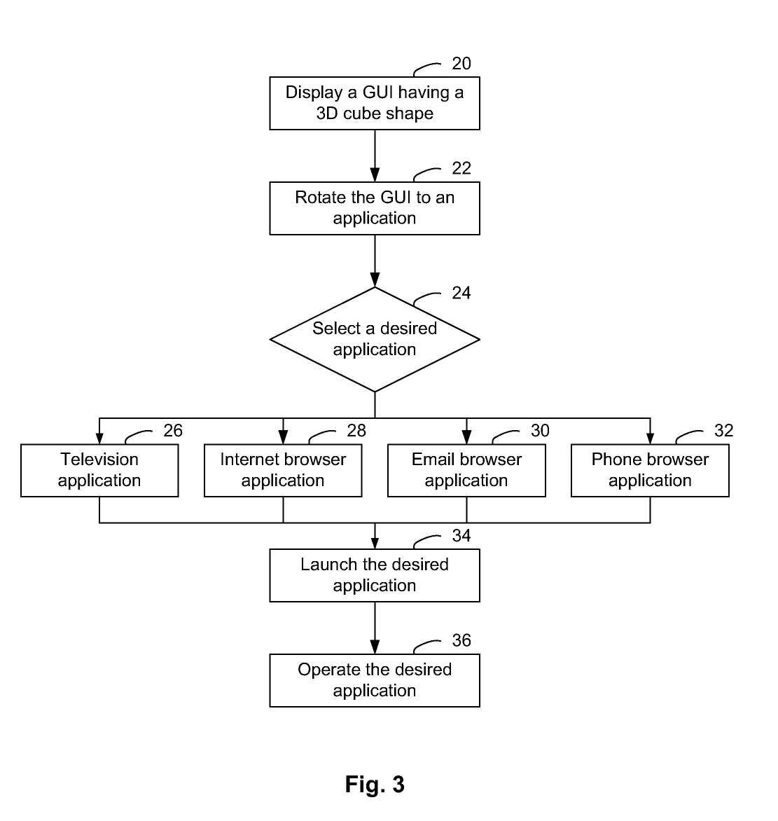

FIG. 3 illustrates a process flow for selecting an application utilizing a GUI according to an embodiment of the present invention. In an embodiment of the present invention, a mobile phone comprises a display, a processor, and a storage device having instructions to display a GUI, wherein the GUI having a shape of a 3D cube with multiple panels. The 3D cube is displayed 20 on the display of the mobile phone. One of the panels of the 3D cube can be associated with a television application; another panel can be associated with an Internet browser application; another panel can be associated with an email browser application; and yet another panel can be associated with a phone application.

A user of the mobile phone can rotate the 3D cube 22 by navigation buttons on the mobile phone and/or by a touch sensitive display of the mobile phone. The user can select a desired application 24 by rotating the 3D cube to display a panel associated with the desired application. Some examples of applications include a television application 26, Internet browser application 28, email browser application 30, and phone application 32. Once the desired application is prominently displayed (e.g., it appears to be the closest displayed panel in terms of depth to the user) on the 3D cube, the user can launch the desired application 34. The desired application can be maximized and displayed on the display, and allow the user to operate the desired application 36.

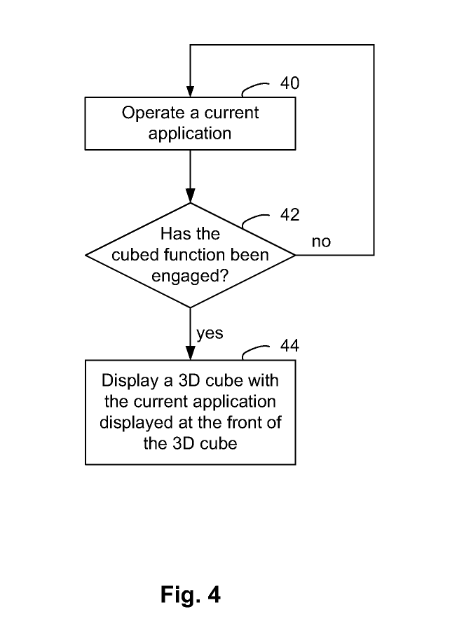

FIG. 4 illustrates a process flow for simultaneously displaying various applications on a GUI according to an embodiment of the present invention. While operating a current application 40 (e.g., a television application, an Internet browser application, an email browser application, a phone application, or other application), it can be determined if the cubed function has been engaged 42. The user can engage the cubed function by selecting a designated button (e.g., a To-cube button) on the mobile phone for launching the 3D cube. For instance, a cubed function can be a virtual button on a touch sensitive screen of the mobile phone, a predefined stroke pattern on the touch sensitive screen, a physical button on the mobile phone, or other input means. A predefined stroke pattern can be any detected stroke pattern. For instance, if a circle motion, a zig-zag motion, or other predefined pattern is sensed by the touch sensitive screen, then this may trigger the cubed function to be engaged.

If the user engages the cubed function 42, then a 3D cube is displayed with the current application displayed on the front panel of the 3D cube 44. If the cubed function is not engaged, then the current application remains running without interruption 40.

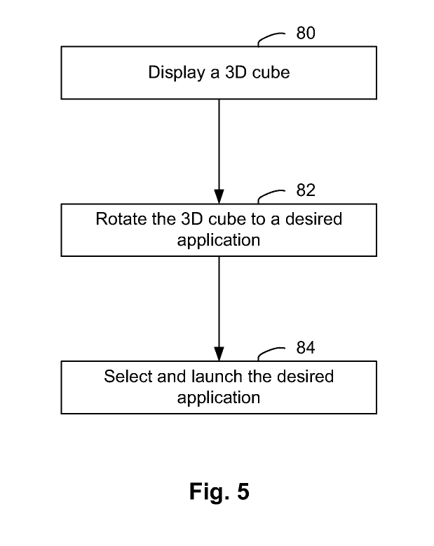

FIG. 5 illustrates a process flow for switching the display of one application to another application on a GUI according to an embodiment of the present invention. A 3D cube with six panels (one panel per rectangular surface) is displayed 80 on the display of an electronic device. The 3D cube can be rotated 82 until a panel with a desired application is prominently displayed on the display of the electronic device. Once a panel with a desired application is displayed and selected, the desired application is launched 84 (i.e., maximized and displayed on the display of the electronic device).

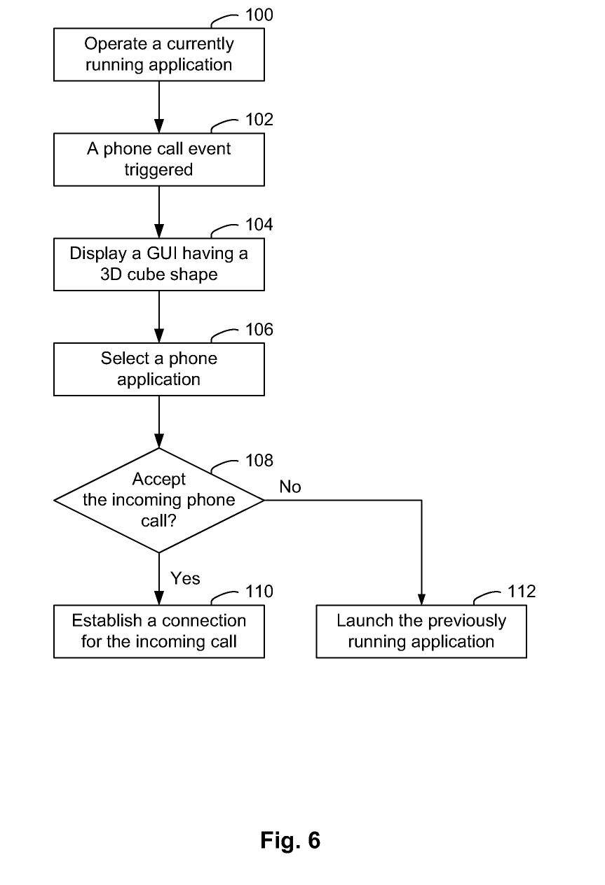

FIG. 6 illustrates a process flow for accepting/denying a phone call according to an embodiment of the present invention. While an application is currently running 100 (e.g., a browser or television application), a phone call event may be triggered 102, indicating that a phone call is incoming. A GUI having a 3D cube shape is displayed on the display of the electronic device 104 to notify the user that there is an incoming phone call. Additionally, standard notification means, such as a ringtone or vibrations emanating from the phone, may be simultaneously triggered to alert the user. The user can then select the phone application 106, and either accept or reject the phone call 108. If the phone call is rejected then previous application can be displayed and launched 112. If the phone call is accepted, then a connection is established with the electronic device 110.

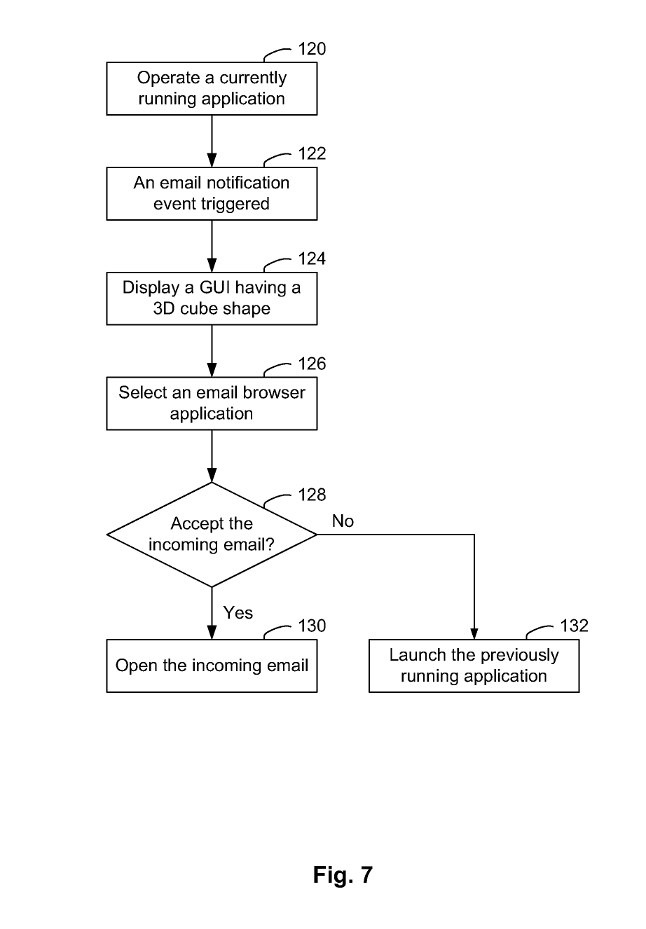

FIG. 7 illustrates a process flow for accepting/denying an instant message or email according to an embodiment of the present invention. While an application is currently running 120 (e.g., a browser or television application), an email notification event may be triggered 122, indicating that an incoming email message has been received. A GUI having a 3D cube shape is displayed on the display of the electronic device 124 to notify the user that there is an incoming email message. Additionally, standard notification means, such as a ringtone or vibrations emanating from the phone, may be simultaneously triggered to notify the user. The user can then select the email browser application 126. Next, a determination whether the user will accept the email is made 128. If the email message is rejected, then the previous application that was launched when the email message alert was triggered is automatically maximized and displayed 132. If the email message is accepted, then the email browser can display the email message on the display of the electronic device 130.

In addition to phone and email alerts, other notifications and similar process flows can be implemented in a like manner, e.g., for instant messages, text messages, and so on and so forth.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for providing a graphical user interface for an electronic device, wherein the electronic device having a display and a plurality of associated applications, comprising the steps:
generating the appearance of a virtual three dimensional object having a plurality of panels, wherein the panels are positioned on the surface of the object;
associating each of the panels to one of the applications; and
displaying two or more of the panels of the object on the display, wherein the associated applications of the panels are displayed.

2. The method of claim 1 further comprising the step, after the displaying step:
rotating the object on the display, wherein the displayed panels are rotated accordingly; and
selecting one of the displayed panels to launch the associated application of the selected panel.

3. The method of claim 2 wherein the display is touch sensitive, and wherein in the rotating step, the object is navigated by receiving commands via the touch sensitive display to rotate the object.

4. The method of claim 2 wherein the electronic device having navigation buttons, and wherein in the rotating step, the object is rotated by receiving commands via the navigation buttons to rotate the object.

5. The method of claim 1 wherein in the displaying step, the displayed panels each having a viewable surface area on the display, and the size of the viewable surface area of a displayed panel is dependent on the position of the displayed panel on the object.

6. The method of claim 2 wherein in the rotating step, the displayed panels each having a viewable surface area on the display, and the size of the viewable surface area of a displayed panel closest to the front of the display is enlarged as the object is rotated.

7. The method of claim 5 wherein in the displaying step, one of the displayed panels has a greater viewable surface area than the other displayed panels.

8. The method of claim 6 wherein in the selecting step, the displayed panel with the greatest surface area is the selected panel.

9. The method of claim 2 wherein the object may be rotated in a plurality of directions.

10. The method of claim 9 wherein the set of applications displayed is a function of the direction of the rotation.

11. The method of claim 1 wherein the object is activated by a preset button of said device.

12. A method for providing a graphical user interface for an electronic device, wherein the electronic device having a display and a plurality of associated applications, comprising the steps:
generating the appearance of a virtual three dimensional object having a plurality of panels, wherein the panels are positioned on the surface of the object;
associating each of the panels to one of the applications;
displaying two or more of the panels of the object on the display, wherein the associated applications of the panels are displayed;
rotating the object on the display, wherein the displayed panels are rotated accordingly; and
selecting one of the displayed panels to launch the associated application of the selected panel;
wherein in the displaying step, the displayed panels each having a viewable surface area on the display, and the size of the viewable surface area of a displayed panel is dependent on the position of the displayed panel on the object.

13. The method of claim 12 wherein the display is touch sensitive, and wherein in the rotating step, the object is navigated by receiving commands via the touch sensitive display to rotate the object.

14. The method of claim 12 wherein the electronic device having navigation buttons, and wherein in the rotating step, the object is rotated by receiving commands via the navigation buttons to rotate the object.

15. The method of claim 12 wherein in the rotating step, the displayed panels each having a viewable surface area on the display, and the size of the viewable surface area of a displayed panel closest to the front of the display is enlarged as the object is rotated.

16. The method of claim 12 wherein the object may be rotated in a plurality of directions.

17. The method of claim 16 wherein the set of applications displayed is a function of the direction of the rotation.

18. The method of claim 12 wherein the object is activated by a preset button of said device.
